(19) United States
(12) Patent Application Publication
(10) Pub. No.: US 2012/0067332 A1
(43) Pub. Date: Mar. 22, 2012

(54) Integrated exhaust gas recirculation and charge cooling system

(75) Inventor: Ko-Jen Wu, Troy, MI (US)

(73) Assignee: GM GLOBAL TECHNOLOGY OPERATIONS, INC., Detroit, MI (US)

(21) Appl. No.: 12/884,610

(22) Filed: Sep. 17, 2010

(51) Int. Cl. F02M 25/07

(52) U.S. Cl. 123/568.12

(57) ABSTRACT

An exhaust gas recirculation system comprises an exhaust driven turbocharger to deliver a compressed intake charge through an intake charge conduit and to an engine. A compressed intake charge cooler receives, cools and transits the compressed intake charge. A cooling system, independent of the engine cooling system delivers coolant to the compressed intake charge cooler to transfer heat from the compressed intake charge thereto and to a cooler. Exhaust gas conduits extend between the exhaust system of the internal combustion engine, from locations upstream and downstream of the exhaust driven turbocharger, to the intake charge conduit. Exhaust gas coolers receive, cool and transit the exhaust gas.

### FEDERAL RESEARCH STATEMENT

This invention was made with Government support under Contract No. DE-FC26-07NT43271, awarded by the Department of Energy. The Government has certain rights in the invention.

### FIELD OF THE INVENTION

Exemplary embodiments of the present invention relate to a recirculated exhaust gas and compressed intake charge cooling system and, more particularly, to an integrated system for cooling both the recirculated exhaust gas charge and the compressed intake charge.

### BACKGROUND

Recirculated exhaust gas (“EGR”) is an important element for both diesel and gasoline engines, particularly engines utilizing intake charge boosting (ex. exhaust driven turbocharger or engine driven supercharger) for both fuel consumption improvements and for reduction in regulated tailpipe exhaust gas emissions.

Typically, the cooling of EGR has been achieved separately from the cooling of the compressed intake charge due to the substantial temperature differential between that of the exhaust gas and the compressed intake charge. EGR is often cooled through a gas-to-liquid charge cooler that utilizes coolant from the engines primary cooling system as the cooling medium. As a result, however, in an engine that has reached normal operating temperatures, the minimum, cooled temperature of the EGR may be limited by the temperature of the engine coolant (the typical temperature coolant range may be 90 to 110 degrees C. as set by a thermostat) in the primary cooling system. The cooling of the compressed intake charge is typically achieved through a gas-to-liquid, or a gas-to-gas (ex. ambient air) type of heat exchanger. Gas-to-gas compressed intake charge cooling is more often found in today's engine applications. However, the utilization of a gas-to-liquid compressed intake charge cooler has the advantage of improved system transient response and has been receiving increased attention as downsized, boosted internal combustion engines are considered as a key solution to improving fuel economy and engine-out emissions.

### SUMMARY OF THE INVENTION

In an exemplary embodiment of the present invention, an exhaust gas recirculation system for an internal combustion engine, the internal combustion engine including a primary cooling system, the exhaust gas recirculation system comprises an exhaust driven turbocharger configured to deliver a compressed intake charge, comprising exhaust gas from an exhaust system and ambient air, through an intake charge conduit and to the internal combustion engine. A compressed intake charge cooler is in fluid communication with the intake charge conduit and is configured to receive, cool and transit the compressed intake charge therethrough. A secondary cooling system, independent of the primary cooling system, is in fluid communication with the compressed intake charge cooler through a cooling system having a cooling medium therein. A cooler is configured to receive the cooling medium through the secondary cooling system conduit and an exhaust gas conduit extends between the exhaust system of the internal combustion engine, from a location upstream of the exhaust driven turbocharger, and the intake charge conduit, at a location upstream of the intake charge cooler. An exhaust gas cooler is in fluid communication with the exhaust gas conduit and is configured to receive, cool and transit the recirculated exhaust gas therethrough, wherein the secondary cooling system is in fluid communication with the exhaust gas cooler through the cooling system conduit for delivery of the cooling medium from the cooling system to, and through, the exhaust gas cooler.

The above features and advantages, and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic view of an internal combustion engine system comprising an exhaust gas recirculation cooling system and a compressed intake charge cooling system embodying features of the present invention; and

FIG. 2 is a schematic view of an internal combustion engine system comprising another embodiment an exhaust gas recirculation cooling system and compressed intake charge cooling system embodying features of the present invention.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

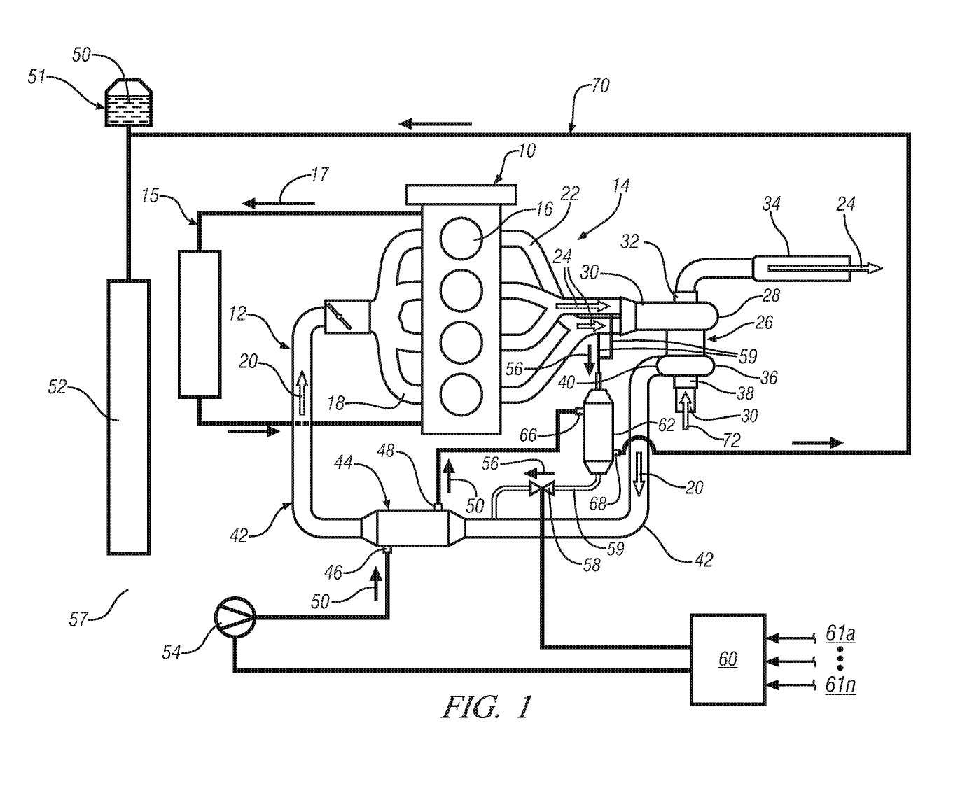

Referring to FIG. 1, an exemplary embodiment is directed to an internal combustion engine 10, in this case an in-line 4 cylinder engine, including an intake system 12 and an exhaust system 14 and a primary cooling system 15 that circulates engine coolant 17 through the engine to remove excess heat. The internal combustion engine 10 includes a plurality of engine cylinders 16 into which a combination of combustion air and fuel are introduced. The combustion air/fuel mixture is combusted resulting in reciprocation of pistons (not shown) therein. The reciprocation of the pistons rotates a crankshaft (not shown) to deliver motive power to a vehicle powertrain (not shown) or to a generator or other stationary recipient of such power (not shown) in various applications of the internal combustion engine 10.

The internal combustion engine 10 includes an intake manifold 18, in fluid communication with the engine cylinders 16 that receives a compressed intake charge from a compressor in the intake system 12 and delivers the charge to the plurality of cylinders 16. The exhaust system 14 includes an exhaust manifold 22, also in fluid communication with the engine cylinders 16 that is configured to remove combusted constituents of the combustion air and fuel (i.e. exhaust gas 24) and to deliver it to an exhaust driven turbocharger 26 that is located in fluid communication therewith. The exhaust driven turbocharger 26 includes an exhaust gas turbine (not shown) that is housed within a turbine housing 28. The turbine housing includes an inlet 30 and an outlet 32. The outlet 32 is in fluid communication with the remainder of the exhaust system 14 and delivers the exhaust gas 24 to an exhaust gas conduit 34 for delivery to various exhaust after treatment devices (not shown) that are configured to treat various regulated constituents of the exhaust gas 24 prior to its release to the atmosphere.

The exhaust driven turbocharger 26 also includes an intake charge compressor wheel (not shown) that is housed within a compressor housing 36. The compressor housing 36 includes a compressor housing inlet 38 and a compressor housing outlet 40. The compressor housing outlet 40 is in fluid communication with the intake system 12 and delivers a compressed intake charge 20 through an intake charge conduit 42 to the intake manifold 18 for mixing with fuel and for combustion within cylinders 16. In an exemplary embodiment, disposed inline between the compressor housing outlet 40 and the intake manifold 18 is a compressed intake charge cooler 44. The compressed intake charge cooler 44 receives heated (due to compression) compressed intake charge 20 from the intake charge conduit 42 and, following cooling of the compressed intake charge 20 therein, delivers it to the intake manifold 18 through a subsequent portion of the intake charge conduit 42. The intake charge cooler 44 comprises an inlet 46 and an outlet 48 for the circulation of a cooling medium 50 (such as a typical glycol-based automotive coolant, or other suitable medium for effective heat transfer in a heat exchanger) supplied through a secondary cooling system 70. In a known manner, the intake charge cooler 44 transfers heat from the compressed intake charge 20 to the cooling medium 50 to thereby reduce the temperature of the compressed intake charge 20 as it transits the intake charge cooler 44. The intake charge cooler inlet 46 receives low temperature coolant medium 50 from the secondary cooling system 70, having a significantly lower temperature than engine coolant 17 from the primary cooling system 15 of the internal combustion engine 10. The low temperature coolant medium 50 is supplied through a cooling system conduit 57 that is in fluid communication with a low temperature cooler or radiator 52 of the secondary cooling system 70. The coolant 50 is under pressure from a cooling medium pump 54. The low temperature cooler 52 is supplied by a cooling medium reservoir 51 in order to maintain a sufficient supply of coolant medium 50 circulating throughout the secondary cooling system 70 during operation of the internal combustion engine 10.

Located in fluid communication with the exhaust system 14, and in the exemplary embodiment shown in FIG. 1, is an exhaust gas conduit 59 for the recirculation of exhaust gas 56 (“EGR”) to the intake system 12 of the engine 10. The EGR conduit 59, in an exemplary embodiment, is located in a high pressure location upstream of the turbine housing inlet 30, and in fluid communication with the exhaust manifold 22. The exhaust gas conduit 59 is configured to extend between, and to divert a portion of the high pressure exhaust gas 24 from the exhaust manifold 22, and to return it to, or recirculate it to, the intake system 12. An exhaust gas recirculation (“EGR”) valve 58 that is in signal communication with a control module such as engine controller 60 adjusts the volumetric quantity of exhaust gas 24 that is diverted as exhaust gas 56 to the intake system 12, based on the particular operating conditions of the engine 10 at any given time. As used herein the term controller may include an application specific integrated circuit (ASIC), an electronic circuit, a processor (shared, dedicated or group) and memory that executes one or more software or firmware programs, a combinational logic circuit, and/or other suitable components that provide the described functionality.

The engine controller 60 collects information regarding the operation of the internal combustion engine 10 from sensors 61a-61n, such as temperature (intake system, exhaust system, engine coolant, ambient, etc.), pressure, exhaust system conditions and/or driver demand. In addition, sensors 61a-61n may measure the temperature of the compressed intake charge 20 and, as a result, may adjust the flow of recirculated exhaust gas 56 through the EGR valve 58 and into the compressed intake charge 20. As a result the compressed intake charge 20 may comprise a continuously variable combination of fresh air 72 and recirculated exhaust gas 56, depending on the commanded quantity of recirculated exhaust gas by the controller 60.

Disposed inline of, and in fluid communication with the EGR conduit 59, between the exhaust manifold 22 and the intake charge conduit 42, is a first exhaust gas cooler 62. The exhaust gas cooler 62 receives high pressure exhaust gas 56 from the EGR conduit 59 and, following cooling of the exhaust gas therein, delivers the cooled, exhaust gas 56 through the EGR conduit 59 to the intake charge conduit 42. The exhaust gas cooler 62 comprises an inlet 66 and an outlet 68 for the circulation of cooling medium 50 therethrough. In a known manner, the exhaust gas cooler 62 transfers heat from the recirculated exhaust gas 56 to the cooling medium 50 to thereby reduce the temperature of the exhaust gas as it transits the cooler 62.

In an exemplary embodiment, the intake charge cooler outlet 48 is in fluid communication with the coolant inlet 66 for transfer of the cooling medium 50 from the intake charge cooler 44 to the exhaust gas cooler 62. After passing through the exhaust gas cooler 62 the cooling medium 50 exits the exhaust gas cooler through the outlet 68 and is returned to the coolant reservoir 51 and/or the low temperature cooler or radiator 52 for the removal of heat before being recirculated through the cooling system 70. In addition, depending on various operating conditions, the controller 60 may also adjust the operation of the cooling medium pump 54 such that the flow of cooling medium 50 is varied through the cooling system 70 to adjust the degree of cooling that the recirculated exhaust gas 56 and compressed intake charge 20 will experience prior to delivery to the intake manifold 18 of the internal combustion engine 10.

The use of a cooling system 70 and coolant medium 50 that is separate and independent from the primary cooling system 15 of the internal combustion engine 10 provides a significant increase in the capacity to cool the recirculated exhaust gas 56 prior to its introduction into the compressed intake charge downstream of the exhaust driven turbocharger 26 as well as to cool the overall compressed intake charge 20 prior to its introduction into the intake manifold 18 of the internal combustion engine 10. This is due to the significantly larger temperature differential that may be realized between the EGR gas temperatures of about 650 degrees C. at the EGR conduit 59 to 25 to 130 degrees C. at the outlet of the EGR cooler 62. Such improved cooling efficiency increases the density of the compressed intake charge 20 which boosts the power efficiency of the internal combustion engine 10. Adding larger and cooler quantities of recirculated exhaust gas 56 to the intake charge 20 reduces the temperature of the combustion event thereby extracting more work from the engine and resulting in less waste heat/energy that must be removed by the primary cooling system 15 of the internal combustion engine 10.

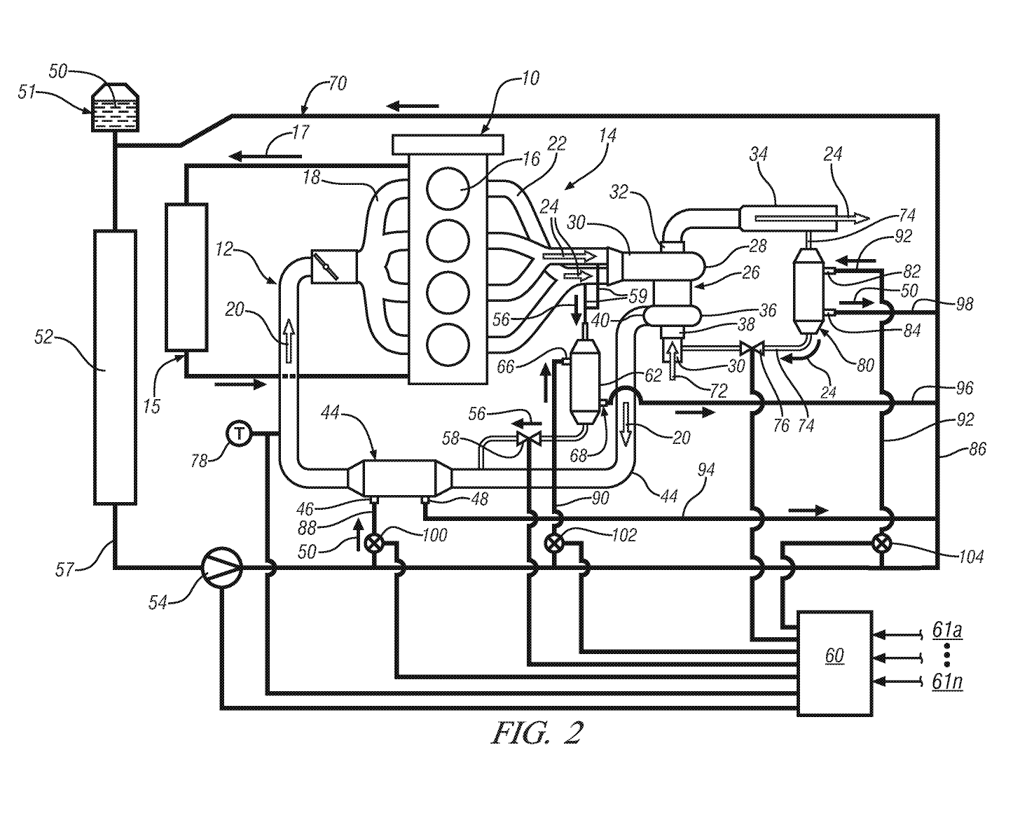

Referring now to FIG. 2, in another exemplary embodiment, in which like numerals represent like features already described, located in fluid communication with the exhaust system 14 downstream of the exhaust driven turbocharger, is a low pressure, EGR conduit 74. The low pressure EGR conduit 74, in the embodiment shown, is located downstream of the turbine housing outlet 32, in communication with the exhaust gas conduit 34. The low pressure EGR conduit 74 is configured to divert a portion of the exhaust gas 24 at a lower pressure following its transit of the exhaust driven turbocharger 26, from the exhaust gas conduit 34 and to return it to, or recirculate it to, the intake system 12 through the compressor housing inlet 38 of the exhaust driven turbocharger 26. A second EGR valve 76 that is in signal communication with the controller 60 adjusts the volumetric quantity of exhaust gas 24 that is diverted to the intake system 12, based on the particular engine operating conditions at any given time.

As indicated above, the engine controller 60 collects information regarding the operation of the internal combustion engine 10 from sensors 61a-61n, such as temperature (intake system, exhaust system, engine coolant, ambient, etc.), pressure, exhaust system conditions, and/or driver demand. In addition the temperature of the compressed intake charge 20 supplied by temperature sensor 78 may result in an adjustment of the flow of recirculated exhaust gas 24 through the EGR valves 58 and 76, respectively, and into the compressed intake charge 20. The compressed intake charge 20 may comprise a continuously variable combination of fresh air 72 and high and low pressure recirculated exhaust gas 56 and 24, respectively, in order to meet EGR requirements over the entire operating range of the internal combustion engine 10.

In an exemplary embodiment, disposed inline of the low pressure EGR conduit 74, upstream of the compressor housing inlet 38 is a second exhaust gas cooler 80. The exhaust gas cooler 80 receives hot exhaust gas 24 from the low pressure EGR conduit 74 and, following cooling of the exhaust gas 24 therein, delivers the cooled, exhaust gas 24 through the EGR conduit 74 to the compressor housing inlet 38. The exhaust gas cooler 80 comprises an inlet 82 and an outlet 84 for the circulation of cooling medium 50 therethrough. In a known manner, the exhaust gas cooler 80 transfers heat from the exhaust gas 24 to the cooling medium 50 to thereby reduce the temperature of the exhaust gas 24 as it transits the cooler 80.

In an exemplary embodiment, an exhaust gas cooling medium bypass loop 86 for the coolant medium 50 extends from the cooling medium pump 54 to the cooler 52 or the coolant reservoir 51. First, second and third parallel cooling circuits comprising supply conduits 88, 90 and 92, respectively, deliver coolant 50 from the bypass loop 86 to each of the compressed intake charge cooler 44, the exhaust gas cooler 62 and the exhaust gas cooler 80, respectively. Similarly, first, second and third parallel return conduits 94, 96 and 98, respectively, remove coolant 50 from each of the compressed intake charge cooler 44, the exhaust gas cooler 62 and the exhaust gas cooler 80, respectively, and return the coolant 50 to the bypass loop 86 for return to the cooler 52 or the coolant reservoir 51. Flow control valves 100, 102 and 104 are positioned in each of the supply conduits 88, 90, and 92, respectively and are configured to allow the flow of cooling medium to each of the compressed intake charge cooler 44, the exhaust gas cooler 62 and the exhaust gas cooler 80, respectively, to allow the system to achieve a desired level of recirculated exhaust gas and intake charge cooling. The flow control valves 100, 102 and 104 are in signal communication with controller 60. Depending on various operating conditions of the internal combustion engine 10, the controller 60 may adjust the valves such that the flow of cooling medium 50 is varied through each of the compressed intake charge cooler 44, the exhaust gas cooler 62 and the exhaust gas cooler 80 to thereby adjust the degree of cooling that the recirculated exhaust gas 24, 56 and compressed intake charge 20 will experience prior to delivery to the intake manifold 18 of the internal combustion engine 10.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. An exhaust gas recirculation system for an internal combustion engine, the internal combustion engine including a primary cooling system, the exhaust gas recirculation system comprising:
an exhaust driven turbocharger configured to deliver a compressed intake charge, comprising exhaust gas from an exhaust system and ambient air, through an intake charge conduit and to the internal combustion engine;
a compressed intake charge cooler in fluid communication with the intake charge conduit and configured to receive, cool and transit the compressed intake charge therethrough;
a secondary cooling system, independent of the primary cooling system, in fluid communication with the compressed intake charge cooler through a cooling system conduit and having a cooling medium therein;
a cooler configured to receive the cooling medium through the secondary cooling system conduit;
an exhaust gas conduit extending between the exhaust system of the internal combustion engine, from a location upstream of the exhaust driven turbocharger, to the intake charge conduit, at a location upstream of the intake charge cooler; and
an exhaust gas cooler in fluid communication with the exhaust gas conduit and configured to receive, cool and transit the recirculated exhaust gas therethrough, wherein the secondary cooling system is in fluid communication with the exhaust gas cooler through the secondary cooling system conduit for delivery of the cooling medium from the secondary cooling system to, and through, the exhaust gas cooler to the cooler following the cooling mediums exit from the exhaust gas cooler.

2. The exhaust gas recirculation system for an internal combustion engine of claim 1, further comprising:
an exhaust gas recirculation valve disposed in the exhaust gas conduit; and
a controller in signal communication with the internal combustion engine and the exhaust gas recirculation valve and configured to operate the exhaust gas recirculation valve to vary the volumetric quantity of recirculated exhaust gas that is delivered to the intake charge conduit based on internal combustion engine operating conditions.

3. The exhaust gas recirculation system for an internal combustion engine of claim 1, further comprising:
a controller in signal communication with the internal combustion engine and a coolant pump and configured to adjust the coolant pump to vary the flow of cooling medium through the secondary cooling system.

4. The exhaust gas recirculation system for an internal combustion engine of claim 3, wherein the flow of the coolant medium is varied based on the temperature of the compressed intake charge in the intake charge conduit.

5. The exhaust gas recirculation system for an internal combustion engine of claim 1, further comprising:
an exhaust gas cooling medium bypass loop extending from a coolant pump to the cooler;
first and second parallel cooling circuits comprising supply conduits to deliver coolant from the exhaust gas cooling medium bypass loop to each of the compressed intake charge cooler and the first exhaust gas cooler;
first and second parallel return circuits comprising return conduits to remove coolant from each of the compressed intake charge cooler and the exhaust gas cooler and return the coolant to the exhaust gas cooling medium bypass loop for return to the cooler; and
flow control valves positioned in each of the first and second parallel cooling circuits configured to vary the flow of cooling medium to each of the compressed intake charge cooler and the exhaust gas cooler.

6. The exhaust gas recirculation system for an internal combustion engine of claim 5, wherein a controller is in signal communication with the valve members and is configured to vary the flow of cooling medium therethrough.

7. The exhaust gas recirculation system for an internal combustion engine of claim 2, further comprising:
a second exhaust gas conduit extending between the exhaust system of the internal combustion engine, from a location downstream of the exhaust driven turbocharger to the intake charge conduit of the internal combustion engine through a compressor housing inlet of the exhaust driven turbocharger;
a second EGR valve in signal communication with the controller to adjust the volumetric quantity of exhaust gas that is diverted to the intake charge conduit based on internal combustion engine operating conditions; and
a second exhaust gas cooler disposed inline of the exhaust gas conduit, upstream of the compressor housing inlet.

8. The exhaust gas recirculation system for an internal combustion engine of claim 7, further comprising:
an exhaust gas cooling medium bypass loop extending from a coolant pump to the cooler;
a parallel cooling circuit comprising a supply conduit to deliver coolant from the exhaust gas cooling medium bypass loop to the second exhaust gas cooler;
a parallel return circuit comprising a return conduit to remove coolant from the second exhaust gas cooler and return the coolant to the exhaust gas cooling medium bypass loop for return to the cooler; and
a flow control valve positioned in the parallel cooling circuit configured to vary the flow of cooling medium to the second exhaust gas cooler.

9. The exhaust gas recirculation for an internal combustion engine of claim 8, wherein the controller is in signal communication with the flow control valve and is configured to vary the flow of cooling medium therethrough.

10. An exhaust gas recirculation system for an internal combustion engine, the internal combustion engine including a primary cooling system, the exhaust gas recirculation system comprising:
an exhaust driven turbocharger configured to deliver a compressed intake charge, comprising exhaust gas from an exhaust system and ambient air, through an intake charge conduit and to cylinders of the internal combustion engine;
a compressed intake charge cooler in fluid communication with the intake charge conduit and configured to receive, cool and transit the compressed intake charge therethrough;
a secondary cooling system, independent of the primary cooling system in fluid communication with the compressed intake charge cooler through a cooling system conduit having a cooling medium therein;
a cooler configured to receive the cooling medium through the secondary cooling system conduit;
a first exhaust gas conduit extending between the exhaust system of the internal combustion engine, from a location upstream of the exhaust driven turbocharger, to the intake charge conduit, at a location upstream of the intake charge cooler;
a first exhaust gas cooler in fluid communication with the first exhaust gas conduit and configured to receive, cool and transit the recirculated exhaust gas therethrough, the secondary cooling system in fluid communication with the first exhaust gas cooler through the cooling system conduit for delivery of the cooling medium from the secondary cooling system to, and through, the first exhaust gas cooler and to the cooler following the cooling mediums exit from the first exhaust gas cooler;
a second exhaust gas conduit extending between the exhaust system of the internal combustion engine, from a location downstream of the exhaust driven turbocharger, and configured to divert a portion of the exhaust gas from the exhaust system and to return it to the internal combustion engine through a compressor housing inlet of the exhaust driven turbocharger; and
a second exhaust gas cooler disposed inline of the second exhaust gas conduit, upstream of the compressor housing inlet.

11. The exhaust gas recirculation system for an internal combustion engine of claim 10, further comprising:
an exhaust gas cooling medium bypass loop extending from a coolant pump to the cooler;
first, second and third parallel cooling circuits comprising supply conduits to deliver coolant from the exhaust gas cooling medium bypass loop to each of the compressed intake charge cooler and the first and second exhaust gas coolers respectively;
first, second and third parallel return circuits comprising return conduits to remove coolant from each of the compressed intake charge cooler and the first and second exhaust gas cooler, respectively, and return the coolant to the exhaust gas cooling medium bypass loop for return to the cooler; and
a first, a second and a third flow control valve positioned in each of the first, second and third parallel cooling circuits respectively, and configured to vary the flow of cooling medium to each of the compressed intake charge cooler and the first and second exhaust gas coolers

12. The exhaust gas recirculation system for an internal combustion engine of claim 10, further comprising:
a controller in signal communication with the internal combustion engine and the first and second exhaust gas recirculation valves, and configured to vary the volumetric quantity of exhaust gas that is delivered to the intake charge conduit.

13. The exhaust gas recirculation system for an internal combustion engine of claim 11, further comprising:
a controller in signal communication with the internal combustion engine and the first, second and third flow control valves respectively, and configured to operate the valves to vary the volumetric quantity of coolant that is delivered to the compressed intake charge cooler and the first and second exhaust gas coolers.
